(19) United States
(12) Patent Application Publication
(10) Pub. No.: US 2011/0259947 A1
(43) Pub. Date: Oct. 27, 2011

(54) RETAIL-READY PACKAGING

(75) Inventor: Jody S. Brittain, North Augusta, SC (US)

(73) Assignee: GEORGIA-PACIFIC CORRUGATED LLC, Atlanta, GA (US)

(21) Appl. No.: 13/091,754

(22) Filed: Apr. 21, 2011

Related U.S. Application Data
(60) Provisional application No. 61/328,060, filed on Apr. 26, 2010.

(51) Int. Cl. B65D 5/54; B31B 3/26; B31B 1/62; B65D 5/00

(52) U.S. Cl. 229/120.011; 229/120.01; 493/162; 493/151

(57) ABSTRACT

A Retail-Ready Packaging container having a substrate capable of forming panels with fold lines therebetween includes a first container portion defined by the panels of the substrate and a second container portion defined by the panels of the substrate. The first container portion and the second container portion are joined at a common region of the substrate that defines a fold line location of the substrate.

### CROSS-REFERENCE TO RELATED APPLICATION

This application claims the benefit of U.S. Patent Application No. 61/328,060, filed Apr. 26, 2010, the entirety of which is incorporated herein by reference.

### BACKGROUND OF THE INVENTION

The subject matter disclosed herein relates generally to Retail-Ready Packaging, and particularly to dual-tray Retail-Ready Packaging.

Typically, products shipped to retail merchants are stored in corrugated boxes or other appropriate outer packaging suitable to protect the products during transportation. Upon arrival to the retailer, the products must be removed from the shipping container and placed on a shelf to present to customers. There exists a need to provide packaging that eliminates the step of removing products from the shipping containers for later placement on shelves thereby reducing stock time while providing a separation of the products therein.

Retail-Ready Packaging (RRP) environments include retail locations where the retail product is not removed from the shipping container before being placed on the shelf. At these retail locations the customer shops directly from the shipping container which has been modified by the person stocking the shelf. Modifications to the container include such things as tearing off perforations to create a dispensing window and/or removing a separate cover piece from the tray base of the shipping container. Some RRP designs do not function efficiently when the shipping container is small in size and/or light in case weight. In contrast, tall, slender rigid product containers such as salad dressings, liquid body soap or other personal care products could have shipping containers that would be suitable for such RRP designs.

Accordingly, and while existing RRP designs may be suitable for their intended purpose, there remains a need in the art for RRP designs that overcomes these drawbacks.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

An embodiment of the invention is a container having a substrate capable of forming panels with fold lines therebetween, and having a first container portion defined by the panels of the substrate and a second container portion defined by other panels of the substrate, where the first and second containers may be substantially identical or asymmetrical in configuration. The first container portion and the second container portion are joined at a common region of the substrate that defines a fold line location of the substrate such that the substrate is continuous and uninterrupted across the common region between the first container portion and the second container portion.

An embodiment of the invention includes a blank for a container. The blank includes a first blank portion, and a second blank portion that may be substantially identical or asymmetrical in configuration to the first blank portion. The first blank portion is joined to the second blank portion at a common region of the blank that defines a fold line location, wherein each of the first blank portion and the second blank portion include a plurality of panels and a plurality of fold lines associated with respective adjacent panels such that the plurality of panels are formable about the associated fold lines to form respective and substantially identical first and second containers that are joined to each other at the common region.

In yet another embodiment of the invention, a method of making a container from a blank is described. A blank is folded at a fold line separating a first blank portion and a second blank portion and the remaining panels are folded to form a dual-tray container.

### BRIEF DESCRIPTION OF THE DRAWINGS

Referring to the drawings wherein like elements are numbered alike in the accompanying Figures:

FIG. 1A is an embodiment of a blank in accordance with the present invention; FIG. 1B is the folded blank of FIG. 1A; FIG. 1C is a partially formed twin-tray container; FIGS. 1D and 1E illustrate front and rear perspective views, respectively, of an assembled twin-tray container in accordance with the embodiment shown in FIG. 1C;

FIG. 2 is a blank for forming a container in accordance with another embodiment of the invention;

FIG. 3A is a blank in accordance with the embodiment of FIG. 2;

FIG. 3B is the folded blank of FIG. 3A; FIGS. 3C and 3D are partially formed twin-tray containers; FIG. 3E is an assembled twin-tray container in accordance with the embodiment shown in FIGS. 3C and 3D;

FIG. 4 is the twin-tray container in accordance with the embodiment of FIG. 2;

FIG. 5 is a twin-tray container in accordance with another embodiment of the invention;

FIG. 6 is a blank in accordance with another embodiment of the invention; and

FIG. 7 is an assembled dual-tray container in accordance with the embodiment of FIG. 6.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific directions, dimensions or parameters described herein and/or shown in the drawing figures. Rather, the description and drawings provided are for the purpose of describing particular embodiments by way of example only, to assist in understanding the claimed invention, and are not intended to be limiting of the invention claimed.

An embodiment of the invention, as shown and described by the various figures and accompanying text provides a dual-tray RRP design derived from a single die cut of cardboard, corrugated cardboard, paperboard or other material that when formed creates two wedge-shaped trays that are adjacent to each other. A glue bond pattern between the trays can be applied in such a manner that the trays can either stay attached to each other and placed in tandem on the retail store shelf, or the glue can be applied in a pattern so the trays are frangible. When an item is shipped to the store, the dual-tray design makes it possible to use a single Half Slotted Container (HSC) cover to cover both trays. However, it will be appreciated that other shroud styles are also possible.

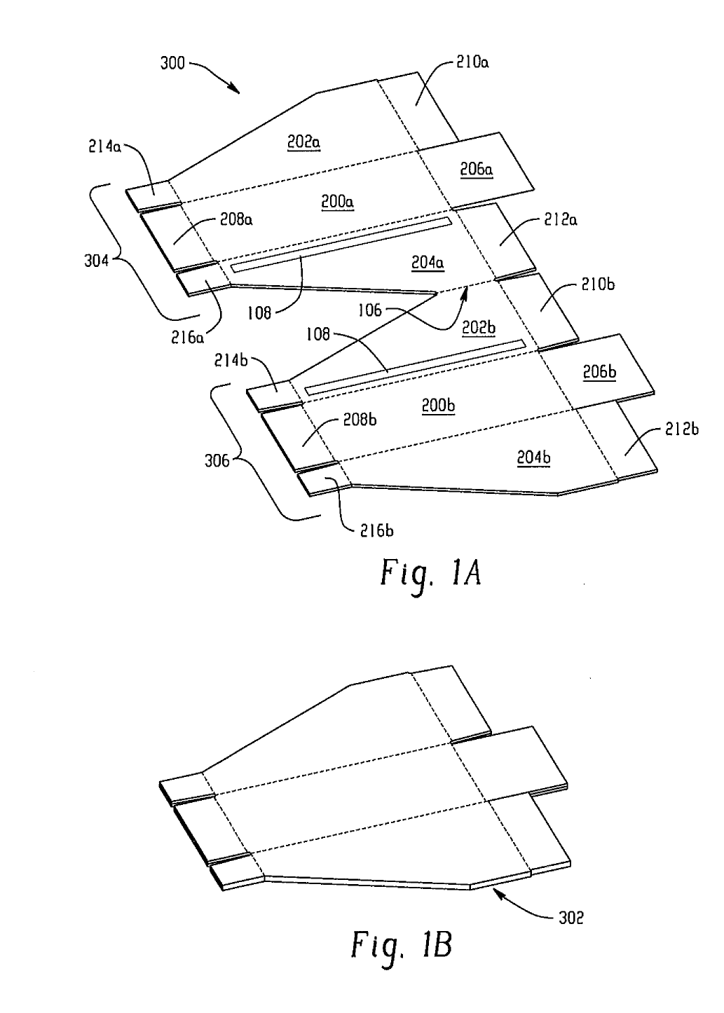

FIGS. 1D and 1E illustrate front and rear perspective views, respectively, of one embodiment of a twin-tray container 100 made from a substrate such as corrugated cardboard, that is capable of being folded to form a multitude of panels. The blank 300 of FIG. 1A has a first blank portion 304 and a second blank portion 306. Solid lines depict cut lines in the substrate forming the container 100, and dashed lines depict fold lines in the substrate forming the container. The first and second blank portions 304, 306 are substantially identical in configuration; the first blank portion 304 is joined to the second blank portion 306 at a common region of the blank that defines a fold line location 106; and, each of the first blank portion 304 and the second blank portion 306 include a plurality of panels 200, 202, 204, 206, 208, 210, 212, 214, 216 (“a” panels and “b” panels) and a plurality of fold lines associated with respective adjacent panels such that the plurality of panels are folded about their associated fold lines to form respective and substantially identical first and second containers 102 and 104 (as shown in FIGS. 1D and 1E) that are joined to each other at the common region 106. FIG. 1B emphasizes the symmetry between blank portions 304 and 306, showing how blank 300 may be folded completely over at fold line 106 to create blank 302.

As illustrated, FIG. 1C depicts a partially formed container 100′ to further highlight the location of the common fold line 106 between the first and second containers 102, 104. Glue 108 (as shown in FIG. 1A) may be disposed to secure one or more panels 212a, 204a, 216a to corresponding panel(s) 210b, 202b, 214b so that blank portions 304 and 306 are adhesively attached to each other on their interior side panels 204a and 202b near bottom panels 200a and 200b when folded as depicted by partially formed container 100′. It is appreciated that other suitable adhesives are contemplated.

FIGS. 1D and 1E show an assembled container 100. The container 100 includes a first container (first tray) 102 defined by panels 200a, 202a, 204a, 206a, 208a, 210a, 212a, 214a, 216a (the “a” panels) of the substrate, and a second container (second tray) 104 defined by panels 200b, 202b, 204b, 206b, 208b, 210b, 212b, 214b, 216b (the “b” panels) of the substrate. Containers 102 and 104 are substantially identical in configuration. Referring to the container 100 in combination with the blank 300, it can be seen that the first container 102 and the second container 104 are joined at a common region of the substrate that defines a fold line location 106. As illustrated, at the fold line location and across the common region between the first container 102 and the second container 104, the substrate is continuous and uninterrupted, as would result from a single die cut of corrugated cardboard for example. However, it is appreciated that the two containers may be detachably secured so that containers 102 and 104 may be separated once one is emptied. It is also appreciated that fold line 106 may be perforated for the purpose of detaching the two containers.

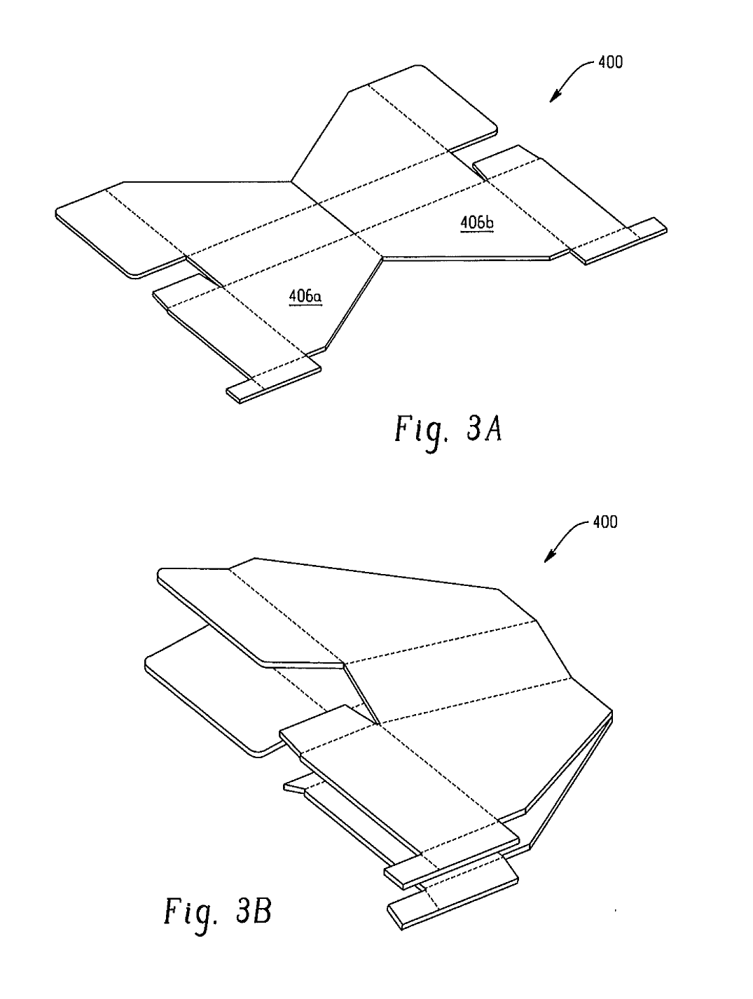

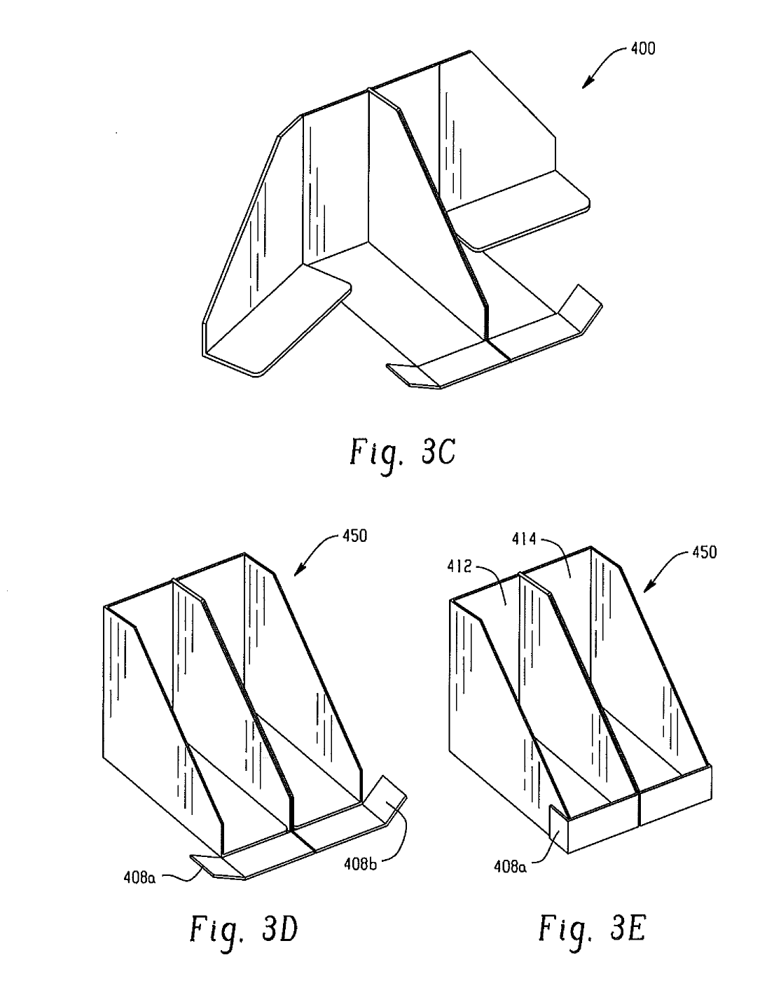

FIGS. 1D and 1E illustrate a container 100 where the adjacent twin-trays 102 and 104 are long in the y-direction (length), narrow in the x-direction (width), and short in the z-direction (height). However, it will be appreciated that other aspect ratios of length, width and height are possible, see, for example, FIGS. 4 and 5. It is also appreciated that panels 210 and 212 (“a” panels and “b” panels) may be secured to panels 206a and 206b so that panels 206a and 206b are positioned outside of panels 210a, 212a and 210b, 212b. Similarly, panels 214 and 216 (“a” panels and “b” panels) may be secured to panels 208a and 208b so that panels 208a and 208b are positioned inside of panels 214a, 216a and 214b, 216b, respectively.

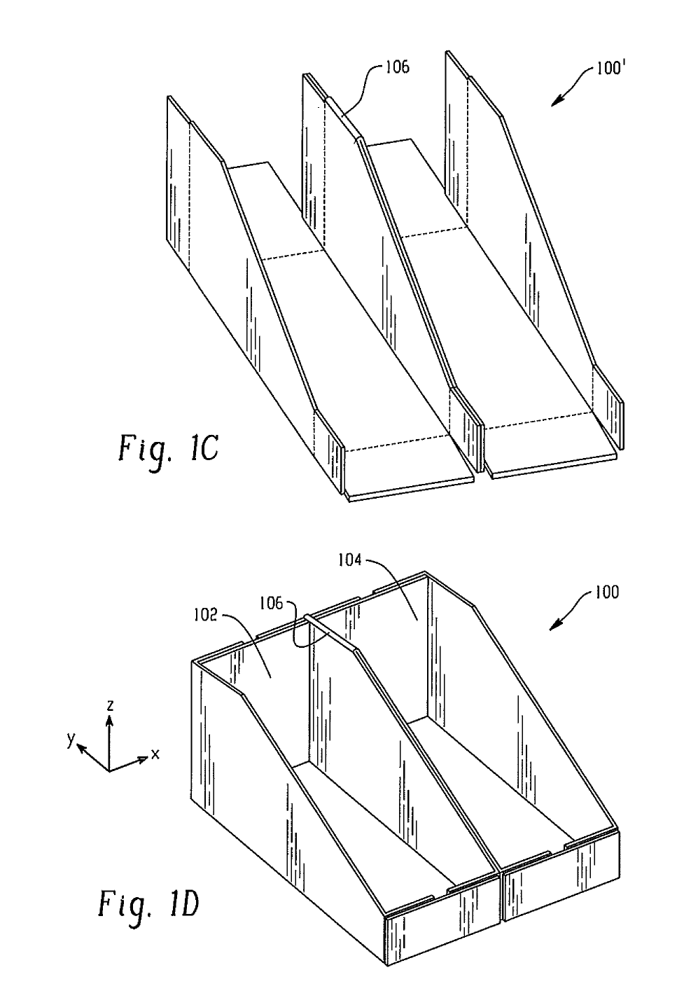

FIG. 2 illustrates an alternate embodiment of the present invention. Blank 400 is suitable for forming twin-tray container 450 (as shown in FIG. 4). It is appreciated that blank 400 includes blank portions 402 and 404 that form substantially identical tray containers 412 and 414, respectively.

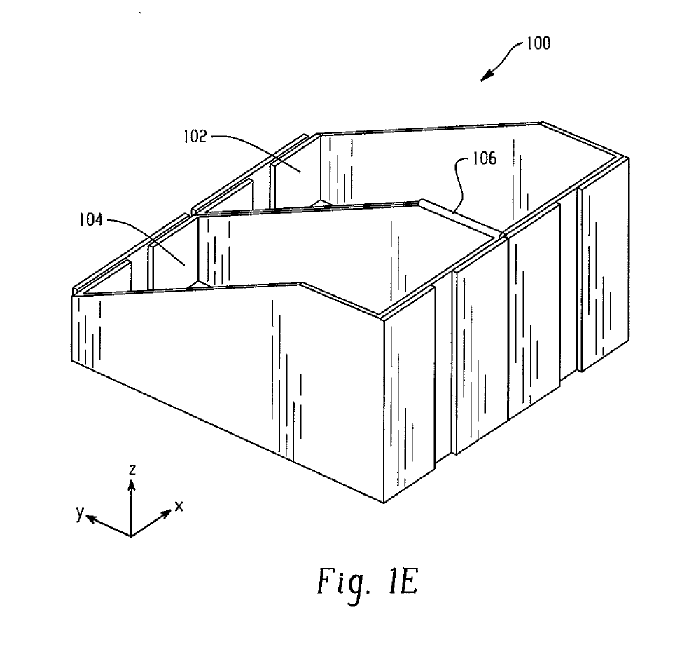

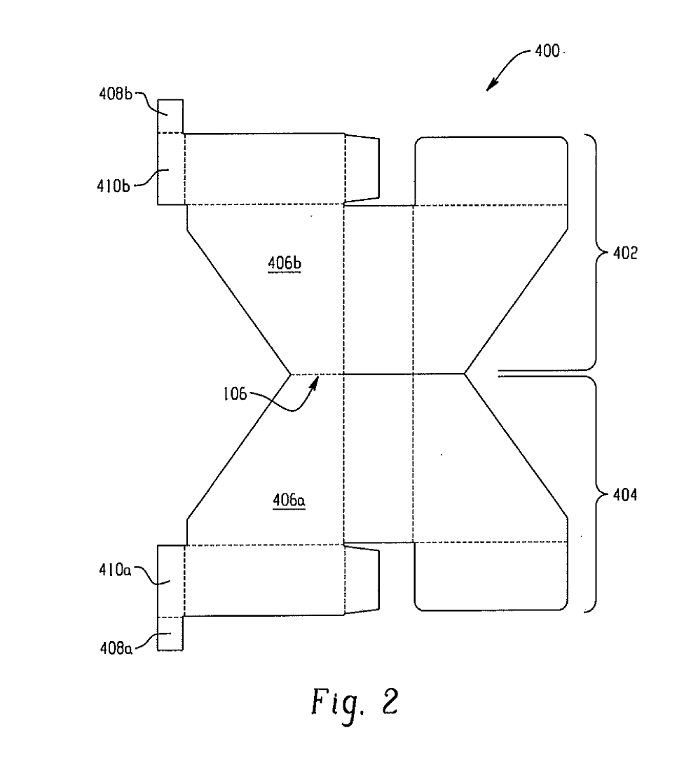

FIGS. 3A, 3B, 3C, 3D and 3E show how blank 400 is folded to assemble twin-tray container 450. An adhesive may be strategically disposed on panels 406a and 406b to at least temporarily secure them together so that trays 412 and 414 are adhesively attached to each other on their respective side panels when folded as depicted in FIGS. 3B and 3C.

FIGS. 3E and 4 show twin-tray container 450. As can be seen in these figures, front side panels 408a and 408b may be secured to the exterior of the resulting container 450. It is also appreciated that other panels may secured to the interior or exterior of their corresponding overlapping panels.

Referring now to FIG. 5, it will be appreciated that other configurations for a dual-tray container fall within the scope of the invention disclosed herein. For example, FIG. 5 shows a twin-tray container 500 that includes a first tray 502 and a second tray 504, but absent front panels and front side panels thereby providing sliding access/removal of a product from the container.

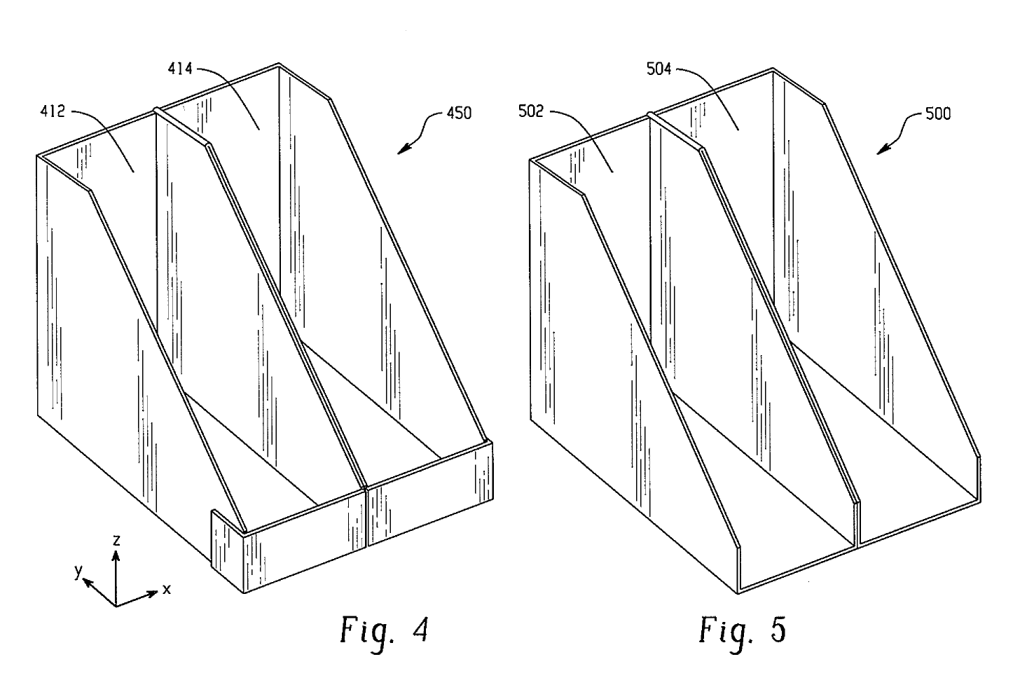

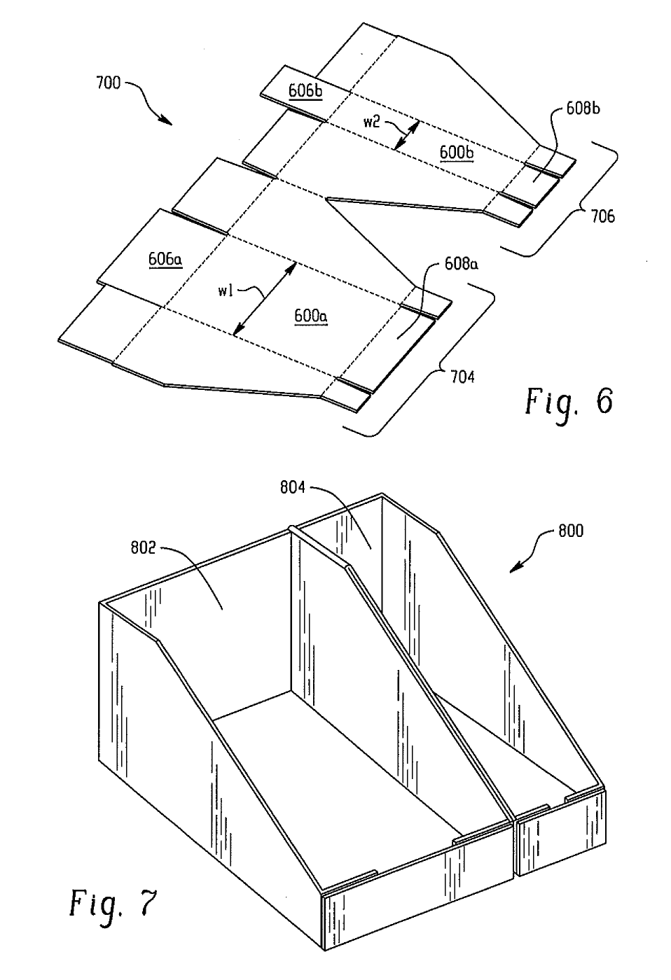

Turning now to FIG. 6, a blank 700 for forming a dual-tray container 800 (as shown in FIG. 7) is shown. The blank 700 of FIG. 6 is similar to the blank 300 of FIG. 1 except that blank 700 is configured to form containers that are asymmetrical in configuration in at least one dimension of corresponding “a” and “b” panels. As illustrated, the blank 700 comprises a first blank portion 704 and a second blank portion 706. The blank portions 704 and 706 are not identical in configuration in that the width w1 of panels 600a, 606a and 608a is wider than the width w2 of panels 600b, 606b and 608b.

FIG. 7 illustrates an assembled container 800 from blank 700. The container 800 includes a first container (first tray) 802 and a second container (second tray) 804. The first and second containers 802 and 804 differ in width as previously described. It is also appreciated that other blanks may be formed such that the first and second containers differ in other aspects such as height and length and with or without front panels and/or front side panels.

While embodiments of the invention are depicted as dual-tray containers, it will be appreciated that the scope of the invention also encompasses three-or-more-tray containers, which may be accomplished by repeating at least a portion of the blank patterns of FIGS. 1A, 2 and/or 6.

As disclosed, some embodiments of the invention may include some of the following advantages: two trays can be kept joined together which results in faster and/or easier shelf replenishment speeds; and the wedge-shaped trays, if kept joined together, provide a divider to maintain two separate rows of retail product, which is an attractive attribute when the retail product tends to move or shift during distribution.

While the invention has been described with reference to several embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed various embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, as used herein, the singular forms “a,” “an,” and “the” are to be interpreted as including the plural, and reference to a particular numerical value includes at least that particular value, unless the context clearly dictates otherwise.

What is claimed is:

1. A retail-ready packaging container, comprising:
a substrate capable of forming panels with fold lines therebetween;
a first container portion defined by the panels of the substrate;
a second container portion defined by the panels of the substrate;
wherein the first container portion and the second container portion are joined at a common region of the substrate that defines a fold line location of the substrate.

2. The container of claim 1, wherein at least one of the side panels of each of the first and second container portions are adjacent to each other.

3. The container of claim 1, wherein the first and second container portions are substantially identical in configuration.

4. The container of claim 1, wherein the first and second container portions are asymmetrical in configuration.

5. The container of claim 1, wherein the first and second container portions include at least one front panel and one front side panel.

6. The container of claim 1, wherein the fold line is perforated and the first and second container portions are separable.

7. The container of claim 1, wherein the first and second container portions share a common cover.

8. The container of claim 1, wherein the substrate is cardboard.

9. The container of claim 8, wherein the cardboard substrate is corrugated.

10. A blank for a container, comprising:
a first blank portion;
a second blank portion;
the first blank portion being joined to the second blank portion at a common region of the blank that defines a fold line location;
wherein each of the first blank portion and the second blank portion comprise a plurality of panels and a plurality of fold lines associated with respective adjacent panels such that the plurality of panels are folded about their associated fold lines to form first and second containers that are joined to each other at the common region.

11. The blank of claim 10, wherein the first and second blank portions are substantially identical in configuration.

12. The blank of claim 10, wherein the first and second blank portions are asymmetrical.

13. The blank of claim 10, wherein the first and second blank portions include at least one front panel and at least one front side panel.

14. The blank of claim 10, wherein the first and second blank portions each include adjacent interior side panels.

15. A method of making a container from a blank, comprising the steps of
providing a blank having a substrate capable of forming panels with fold lines therebetween;
wherein the blank has a first blank portion defined by panels of the substrate;
wherein the blank has a second blank portion defined by panels of the substrate;
wherein the blank is capable of forming a first container portion and a second container portion which are joined at a common region of the substrate that defines a fold line location of the substrate;
folding the blank at a fold line separating the first blank portion and the second blank portion; and
folding panels that comprise the first blank portion and the second blank portion to form a container having multiple container portions.

16. The method of claim 15 further comprising the step of folding side panels of each of the first and second blank portions such that at least one of the respective side panels of each blank portion are adjacent to each other.

17. The method of claim 15 further comprising the step of folding a front panel and a side panel of the first or second blank portion to form an at least partially enclosed interior tray of the container.

18. The method of claim 15 further comprising the step of adhesively attaching the panels connected by the fold line.
